(19) United States
(12) Patent Application Publication
(10) Pub. No.: US 2007/0250537 A1
(43) Pub. Date: Oct. 25, 2007

(54) METHOD OF MATCHING THE CONTENTS OF A CONTAINER WITH INFORMATION PERTAINING TO ITS USE

(76) Inventor: Jean-Francois Bouchard, Outremont (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/682,531

(22) Filed: Mar. 6, 2007

Related U.S. Application Data
(60) Provisional application No. 60/778,976, filed on Mar. 6, 2006.

(51) Int. Cl. G06F 17/30

(52) U.S. Cl. 707/104.1

(57) ABSTRACT

A method and apparatus for matching the contents of a container with information pertaining to its use. In an embodiment, the method is used for matching a beverage with a meal. The method comprises providing an identification of a given one of the beverage and the meal, the identification defining uniquely the given one of the beverage and the meal; accessing a database comprising a table associating each of a plurality of beverages with a corresponding one of a plurality of meals; querying the database using the identification; and the database returning a subset of a corresponding identified ones of the plurality of beverages and the plurality of meals. Alternatively, the method is used for finding medicinal information associated with a medicinal product.

### RELATED APPLICATIONS

This patent application claims priority of U.S. Patent Application No. 60/778,976, entitled “A method of matching the contents of a container with information pertaining to its use” that was filed on Mar. 6, 2006, the specification of which is hereby incorporated by reference.

### FIELD OF THE INVENTION

This invention relates to the field of computers. More precisely, this invention pertains to a method and apparatus for matching the contents of a container with information pertaining to its use.

### BACKGROUND OF THE ART

Being able to match products together is very desirable since matched products create a combination rather than an aggregation.

Unfortunately, matching products requires a knowledge. While in some cases the knowledge may be simple to acquire, in some other cases, the knowledge is very costly and cumbersome to acquire. Acquiring the knowledge may require years of studies or work in some cases such as for instance in the art of matchmaking wines and meals together.

A user may therefore be forced to rely on a third party to achieve the matching. This is the source of a lot of drawbacks since the user is dependent on the third party. For instance, the third party may not be available to provide such information. Moreover, the third party may not be fully skilled, etc.

There is a need for a method and apparatus that will overcome at least one of the above-mentioned drawbacks.

Features of the invention will be apparent from review of the disclosure, drawings and description of the invention below.

### SUMMARY

The invention provides a method for matching wines with a selection of meals, the method comprising providing codes on containers of the wines, each one of the wines having a specific code, accessing a database, the database comprising a meals table associating the codes associated with a respective one of the wines to the selection of meals, querying the database using at least one of the codes, the database returning a subset of the selection of meals.

The invention further provides a method for matching a beverage with a food product, the method comprising providing a code of a given one of the beverage and the food product, the code defining uniquely the given one of the beverage and the food product, accessing a database comprising a meals table associating each of a plurality of beverages with at least one of a plurality of food products and further comprising a beverages table associating each of the plurality of food products with at least one of the plurality of beverages, querying the database using the code, the database returning a subset of a corresponding identified ones of the plurality of beverages and the plurality of food products.

The invention further provides a method for finding medicinal information associated to a medicinal product, the method comprising providing codes on containers of the medicinal product, each one of the medicinal product having a specific code, accessing a database, the database comprising a table associating the codes associated with a respective one of the medicinal product to the medicinal information, querying the database using at least one of the codes, the database returning the medicinal information.

### DESCRIPTION OF THE DRAWINGS

In order that the invention may be readily understood, embodiments of the invention are illustrated by way of example in the accompanying drawings.

FIG. 1 is a flowchart showing an embodiment of a method for matching a beverage with a food product using a database.

FIG. 2 is a flowchart showing how to create the database according to one embodiment.

FIG. 3 is a block diagram showing an embodiment of a system for matching a beverage with a food product using a database; the system comprises a plurality of client units connected to a server via a data network.

FIG. 4 is a block diagram showing an embodiment of a client unit comprising a code scanning unit, a processing unit and a network interface.

FIG. 5 shows an embodiment of the database of an embodiment of a server used for matching a beverage with a food product.

Further details of the invention and its advantages will be apparent from the detailed description included below.

### DETAILED DESCRIPTION OF PREFERRED EMBODIMENTS

In the following description of the embodiments, reference to the accompanying drawings is by way of illustration of an example by which the invention may be practiced. It will be understood that other embodiments may be made without departing from the scope of the invention disclosed.

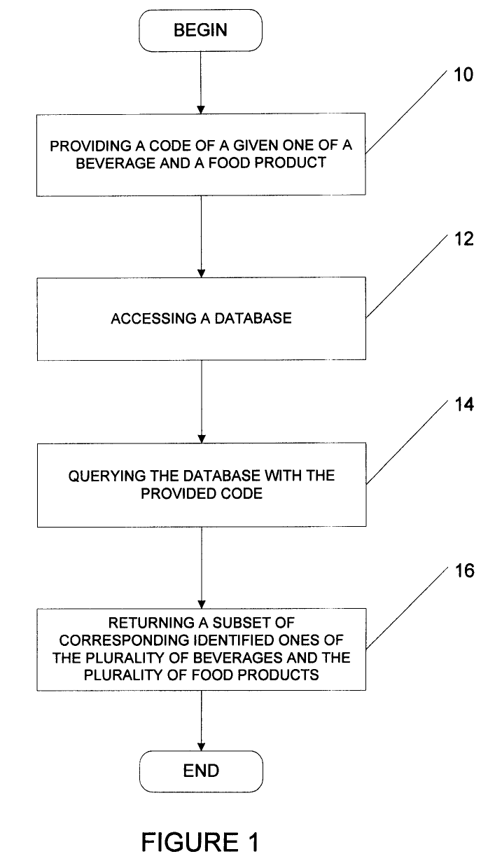

Referring to FIG. 1, there is shown an embodiment of a method for matching a beverage with a food product. It will be appreciated that this is very desirable in many places or situation where a choice has to be exercised such as in a restaurant for instance or when shopping.

It should be appreciated by the skilled addressee that a beverage is intended to mean any types of beverage, i.e. alcoholic beverages as well as non-alcoholic beverages.

Also the skilled addressee should appreciate that a food product is intended to mean any type of product that may be prepared by a skilled person for consumption purposes. For instance, the food product may be any one of a piece of meat, a cheese, a combination of processed food or the like.

According to step 10, a code of a given one of the beverage and the food product is provided. More precisely, the code provided defines uniquely the given one of the beverage and the food product. It one embodiment, the code provided comprises a bar code. Alternatively, the code provided comprises a sequence of letters and numbers. Alternatively, the code provided comprises a RFID tag. It will be appreciated by the skilled addressee that in one embodiment a user may desire to find a beverage which matches a food product while in another embodiment, the user may desire to find a food product that match a beverage.

According to step 12, a database comprising a table associating each of a plurality of beverages with a corresponding one of a plurality of food products is accessed. The skilled addressee will appreciate that the database may be accessed using various techniques. For instance, the database may be accessed locally using a terminal or the like. Alternatively, the database may be accessed remotely via a data network. The data network may comprise at least one of a local area network (LAN), a metropolitan area network (MAN) and a wide area network (WAN) such as the Internet.

According to step 14, the database is queried using the code provided.

According to step 16, the database returns a subset of corresponding identified ones of the plurality of beverages and the plurality of food products.

It will be appreciated that the subset of corresponding identified ones of the plurality of beverages and the plurality of food products may be provided according to various schemes. For instance, the subset of corresponding identified ones may be outputted sorted according to various criteria. The criteria may be selected from a group consisting of price, a type of diet, availability, an indication of a person having populated the database, etc.

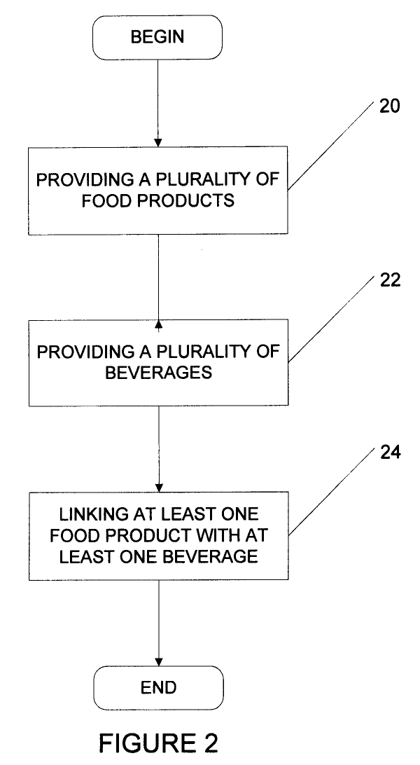

Now referring to FIG. 2, there is shown an embodiment for creating the database.

According to step 20, a plurality of food products is provided. The plurality of food products is preferably provided by an operator based on various criteria. The criteria may be selected from a group consisting of availability, price, a type of diet, etc.

According to step 22, a plurality of beverages is provided. The plurality of beverages is preferably provided by an operator based on various criteria. The criteria may be selected from a group consisting of availability, price, etc.

The skilled addressee will appreciate that step 22 may be alternatively performed before step 20.

Still referring to FIG. 2 and according to step 24, at least one food product is linked to at least one beverage. The skilled addressee will appreciate that the linking may be performed according to various ways. For instance, a “basic” linking may be performed. The result of such simple linking may be “food product a” is linked to “beverage b” which is similar to the “beverage b” is suitable with the “food product a”.

The linking may be alternatively performed using various criteria such as “food product a” is link to “beverage b” under “conditions”. For instance, the conditions may be a particular diet such as a given weight loss diet, a vegetarian diet, a vegan diet, a Kosher diet or the like. The result of such linking may be “beverage b” is suitable with “food product”. In an alternative embodiment, the linking may comprise the associating of a note or comment. It should be understood that the note or comment may be put at the beginning by a first operator creating the database. Alternatively, notes and comments may be collected throughout time and may originate from the feedback of users. The skilled addressee will appreciate that this is of great value for an individual accessing the database and using the method.

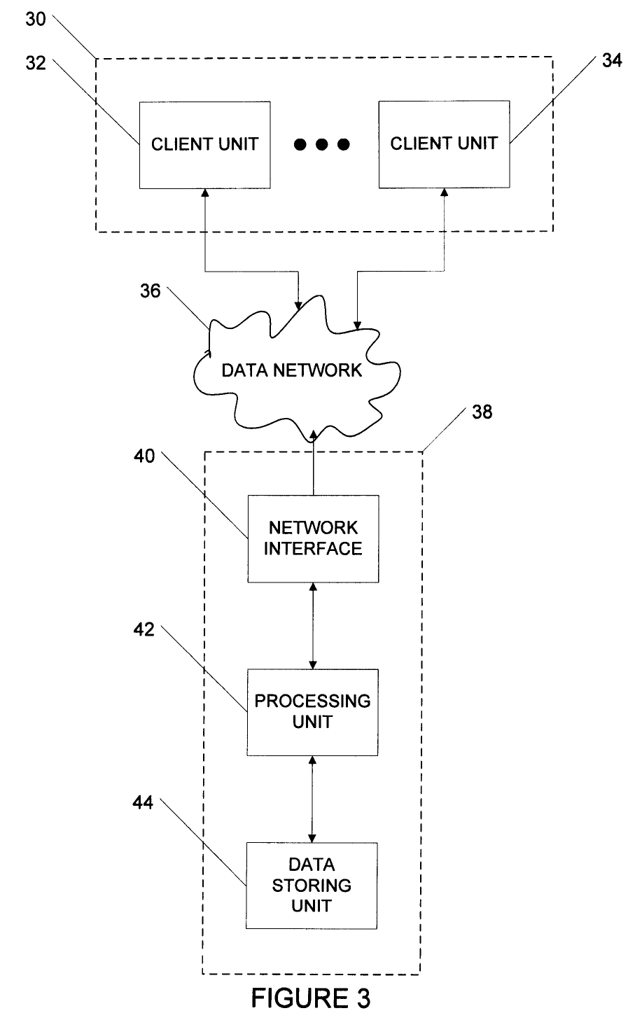

Now referring to FIG. 3, there is shown an embodiment of a system for matching a beverage with a food product.

The system comprises a plurality of client units 30 and a server 38.

The plurality of client units 30 is connected to the server 38 via a data network 36.

In the embodiment disclosed in FIG. 3, the plurality of client units 30 comprises client unit 32 and client unit 34.

The data network 36 may be any type of networks adapted for transmitting data. The data network 36 may comprise at least one of a local area network (LAN), a metropolitan area network (MAN) and a wide area network (WAN) such as the Internet.

The server unit 38 comprises a network interface 40, a processing unit 42 and a data storing unit 44.

The network interface 40 is used to connect the server unit 38 to the data network 36. The skilled addressee will appreciate that the network interface 40 depends on the data network 36 used.

The processing unit 42 is used to receive a request from a client unit of the plurality of client units 30 via the data network 36 and the network interface 40. The processing unit 42 accesses the data storing unit 44 using the request and provides a corresponding result. The corresponding result is provided to the client unit which has provided the request.

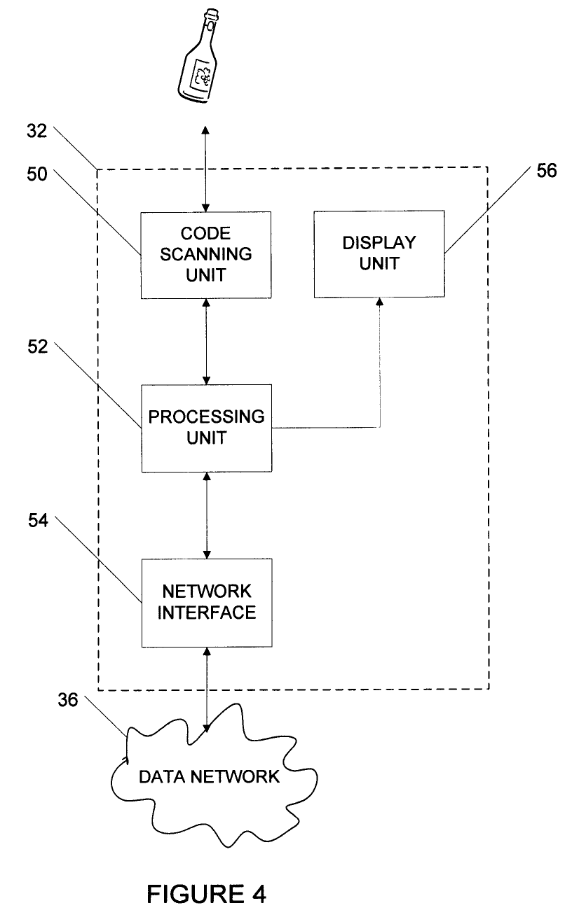

Now referring to FIG. 4, there is shown an embodiment of the client unit 32.

The client unit 32 comprises a code scanning unit 50, a processing unit, a display unit 56 and a network interface 54.

The code scanning unit 50 is used to scan a code affixed to one of a food product and a beverage. The skilled addressee will appreciate that the code scanning unit 50 used depends on the type of code used. In one embodiment, the code scanning unit 50 comprises a bar code reader. Alternatively, the code scanning unit 50 comprises a RFID tag reader.

The display unit 56 is used to display information to a user. The display unit 56 may be anyone of a cathode ray tube (CRT) display, an LCD screen, a plasma screen, a projector display or the like.

The network interface 54 is used to connect the client unit 32 to the data network 36. The skilled addressee will appreciate that the network interface 54 depends on the data network 36 used.

The processing unit 52 is used for receiving a code from the code scanning unit 50 and to generate a request comprising the code. The request is then provided to the server unit 38 via the network interface 54 and the data network 36.

The skilled addressee will appreciate that various type of processing units may be used.

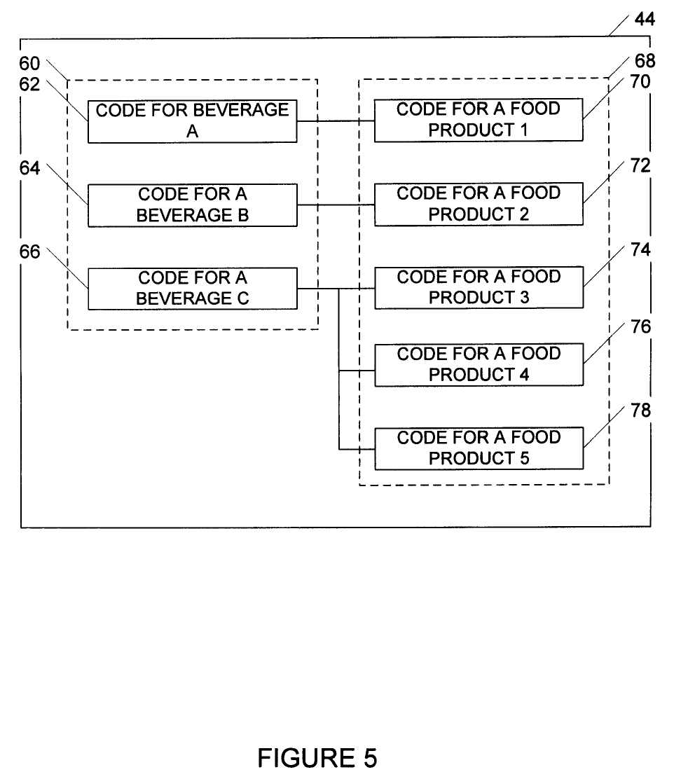

Now referring to FIG. 5, there is shown an embodiment of the data storing unit 44. The data storing unit 44 comprises a plurality of codes 60 for a corresponding beverage. The data storing unit 44 further comprises a plurality of codes 68 for a corresponding food product.

In the embodiment disclosed, the plurality of codes 60 for a corresponding beverage comprises a code 62 for beverage A, a code 64 for beverage B and a code 66 for beverage C.

In the embodiment disclosed, the plurality of codes 68 for a corresponding food product comprises a code 70 for food product 1, a code 72 for food product 2, a code 74 for food product 3, a code 76 for food product 4 and a code 78 for food product 5.

Still referring to FIG. 5, there is shown that the code 62 for beverage A is linked to the code 70 for food product 1, that the code 64 for beverage B is linked to the code 72 for food product 2, that the code 66 for beverage C is linked to the code 74 for food product 3, to the code 76 for food product 4 and to the code 78 for food product 5.

It will be appreciated that various embodiments of the data storing unit 44 may be used. For instance, it will be understood that the data storing unit 44 may comprise a meals table associating each of a plurality of beverages with at least one of a plurality of food products and further may also further comprise a beverages table associating each of said plurality of food products with at least one of the plurality of beverages

The skilled addressee will understand that the embodiment disclosed is one of many possible embodiments. As explained above, notes or comments may further be provided in the database 44. For instance, the database may further comprise a recipes table associating each food product with a selection of recipes, the recipes including a list of ingredients and instructions.

Also it should be understood that a rating may be given by an operator on a returned subset of data using a user interface. It will be appreciated that the rating may or may not be used to update the database. Also it will be appreciated that the rating may be weighted according to a “pre-qualification” of the user. The “Pre-qualification” comprises recognition of the expertise of the user by the operator of the system/database. An example may be a recognized wine taster.

It will be further appreciated that the method disclosed may be advantageously used for finding medicinal information associated with a medicinal product. In such embodiment, codes are provided on containers of the medicinal product. Each one of the medicinal product has a specific code. A database comprising a table associating the codes associated with a respective one of the medicinal product to the medicinal information may then be accessed. The database may then be queried using at least one of the codes. The database may then return the medicinal information.

It will be appreciated that in one embodiment the codes are selected from a group consisting of bar codes and RFID tags.

The skilled addressee will appreciate that the method for matching a food product with a beverage disclosed above is of great advantage as it enables a user to accurately perform a match and to therefore avoid deceptions or bad surprises. For instance, the skilled addressee will appreciate that such as method may be advantageously used in restaurants for instance wherein the choice of a proper wine bottle may be cumbersome for a novice and results in frustration and loss of money.

Although the above description relates to a specific preferred embodiment as presently contemplated by the inventor, it will be understood that the invention in its broad aspect includes mechanical and functional equivalents of the elements described herein.

I claim:

1. A method for matching wines with a selection of meals, the method comprising:
providing codes on containers of said wines, each one of said wines having a specific code;
accessing a database, said database comprising a meals table associating said codes associated with a respective one of said wines to said selection of meals;
querying said database using at least one of said codes,
said database returning a subset of said selection of meals.

2. A method for matching a beverage with a food product, the method comprising:
providing a code of a given one of said beverage and said food product, said code defining uniquely said given one of said beverage and said food product,
accessing a database comprising a meals table associating each of a plurality of beverages with at least one of a plurality of food products and further comprising a beverages table associating each of said plurality of food products with at least one of said plurality of beverages;
querying said database using said code;
said database returning a subset of a corresponding identified ones of said plurality of beverages and said plurality of food products.

3. The method as claimed in claim 2, wherein said database further comprises a recipes table associating each food product with a selection of recipes, said recipes comprising a list of ingredients and instructions.

4. The method as claimed in claim 2, wherein said code is selected from a group consisting of bar code and RFID tag.

5. The method as claimed in claim 2, further comprising receiving feedback from users of said database.

6. The method of claim 2, further comprising said user giving a rating on said returned subset.

7. The method as claimed in claim 6, wherein said rating is used to update said database.

8. The method as claimed in claim 1, wherein said querying comprises scanning said code.

9. The method as claimed in claim 6, further comprising weighting said rating according to a pre-qualification of said user.

10. The method as claimed in claim 8, further comprising said user giving a user rating to another user's meal rating and weighting said meal rating according to said user rating.

11. A method for finding medicinal information associated to a medicinal product, the method comprising:
providing codes on containers of said medicinal product, each one of said medicinal product having a specific code;
accessing a database, said database comprising a table associating said codes associated with a respective one of said medicinal product to said medicinal information;
querying said database using at least one of said codes,
said database returning said medicinal information.

12. The method as claimed in claim 11, wherein said codes are selected from a group consisting of bar codes and RFID tags.

13. The method as claimed in claim 11, wherein said querying comprises scanning said at least one code.
